(19) United States
(12) Patent Application Publication
(10) Pub. No.: US 2006/0260203 A1
(43) Pub. Date: Nov. 23, 2006

(54) Window assembly for horse trailer

(76) Inventors: Eric V. Wong, Elkhart, IN (US); Christopher M. Albert, Granger, IN (US); Phillip Roberts, Goshen, IN (US)

Correspondence Address: GIFFORD, KRASS, GROH, SPRINKLE & CITKOWSKI, P.C, PO BOX 7021, TROY, MI, 48007-7021, US

(21) Appl. No.: 11/429,853

(22) Filed: May 8, 2006

Related U.S. Application Data
(60) Provisional application No. 60/682,084, filed on May 18, 2005.

(51) Int. Cl. E05B 65/06; E05C 19/00; E05C 17/00

(52) U.S. Cl. 49/394

(57) ABSTRACT

A window assembly includes an outer frame assembly having opposing side and opposing upper and lower portions for providing a boundary for the outer frame assembly. An inner frame assembly is disposed within the outer frame assembly. The inner frame assembly includes opposing sides and opposing upper and lower portions for providing a boundary for the inner frame assembly. At least one window pane is slidably received in the inner frame assembly. A vertical post extends from the lower portion to the upper portion of the inner frame assembly. A latch is disposed at the upper portion of the vertical post. A latch handle is slidingly received by the vertical post. The latch handle is operably connected to the latch for actuating the latch between open and locked positions.

### FIELD OF THE INVENTION

The invention relates to horse trailer window assemblies.

### BACKGROUND OF THE INVENTION

There is a need in the art of horse trailer window assemblies for a feed window that is formed as a unit, allowing for quick and economic installation in a trailer without separate installations of latches and latch handles. Additionally, there is a need in the art of horse trailer windows for a feed window having the latch release that is easily accessible and ergonomic allowing for a user to exert more control over a released window.

### SUMMARY OF THE INVENTION

In an embodiment, the window assembly includes an outer frame assembly having opposing sides and opposing upper and lower portions for providing a boundary for the outer frame assembly. An inner frame assembly is disposed within the outer frame assembly. The inner frame assembly includes opposing sides and opposing upper and lower portions for providing a boundary for the inner frame assembly. At least one window pane is slidably received in the inner frame assembly. A vertical post extends from the lower portion to the upper portion of the inner frame assembly. A latch is disposed at the upper portion of the vertical post. A latch handle is slidingly received by the vertical post. The latch handle is operably connected to the latch for actuating the latch between open and locked positions.

### BRIEF DESCRIPTION OF THE DRAWINGS

FIG. 1 is a rear view of a window assembly according to a first embodiment;

FIG. 2 is a side view of a window assembly in a latched position according to a first embodiment;

FIG. 3 is a side view of a window assembly according to a first embodiment with the window in the unlatched position and partially tilted;

FIG. 4 is a top sectional view of a first embodiment of a window assembly according to the present invention;

FIG. 5 is a partial view of the latch member and central pillar of the window assembly in the locked or closed position;

FIG. 6 is a partial view of a latch member and central pillar in the open position;

FIG. 7 is a front view of a second embodiment of a window assembly of the present invention;

FIG. 8 is a side view of a window assembly according to a second embodiment;

FIG. 9 is a top sectional view of a second embodiment of a window assembly according to the present invention; and

FIG. 10 is a scaled-up detailed front view of the vertical post latch and outer frame assembly according to a second embodiment of the present invention.

FIG. 11 is an environmental view of a first embodiment of the window assembly installed on a trailer with the window assembly in the latched and unlatched positions.

FIG. 12 is an environmental view of a second embodiment of the window assembly installed on a trailer with the window assembly in the latched and unlatched positions;

FIG. 13 is a perspective view of a latch handle according to the present invention;

FIG. 14 is a side view of a latch handle according to the present invention;

FIG. 15 is a rearview of a latch handle according to the present invention;

FIG. 16 is a partial perspective view of the vertical post with the latch mechanism;

FIG. 17 is a partial exploded view of the latch handle and vertical post;

FIG. 18 is a partial exploded view of the latch handle and vertical post.

### DESCRIPTION OF THE INVENTION

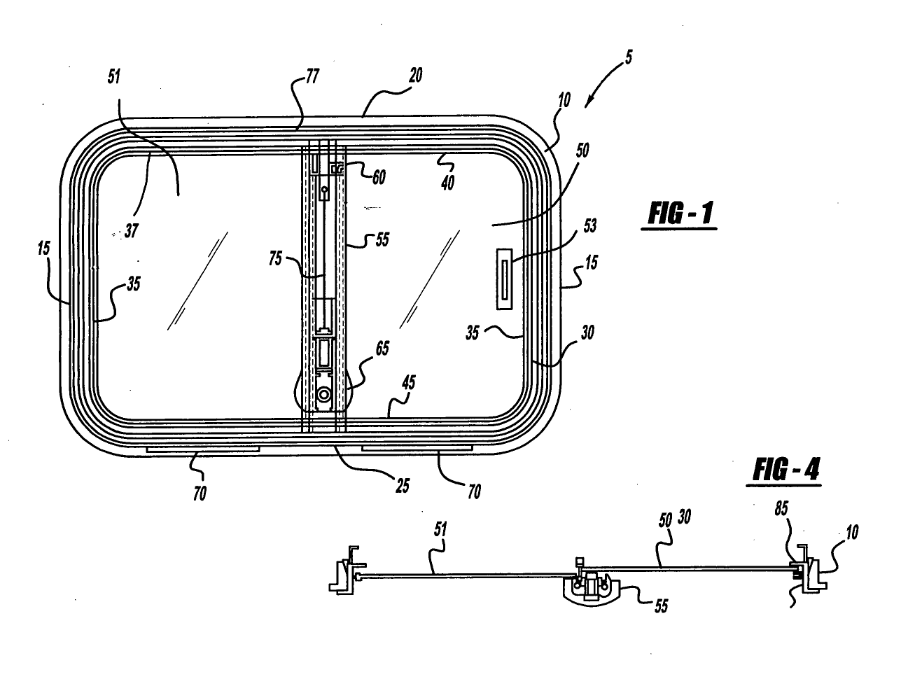

Referring to FIG. 1, there is shown a window assembly 5 according to a first embodiment of the present invention. The window assembly 5 includes an outer frame assembly 10 having opposing sides 15 and opposing upper and lower portions 20, 25. An inner frame assembly 30 is disposed within the outer frame assembly 10 and also includes opposing sides 35 and opposing upper and lower portions 40, 45. At least one window pane 50 is received within channels 37 formed in the inner frame assembly 30. The window pane 50 may include slides attached to the window pane 50 that are received in the channels 37 described above. Additionally, a gasket may be associated with the channels 37 to provide a water tight seal for the window pane 50.

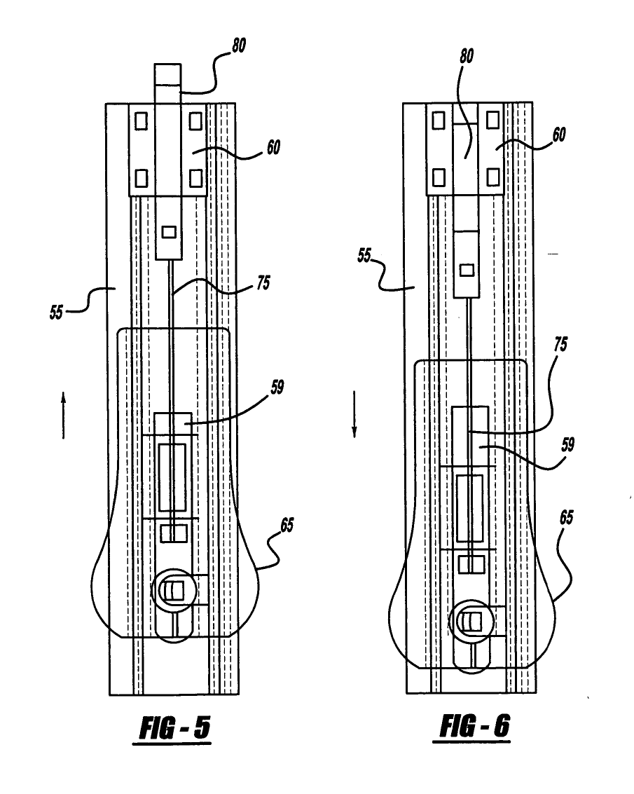

In one aspect of the present invention, two window panes 50, 51 may be offset from each other, as best shown in FIG. 4, and are received in the channels 37 outlined above. Such an arrangement allows for sliding movement of the window panes 50, 51 within the inner frame assembly 30. Additionally, one of the window panes 50, 51 may be fixed relative to the inner frame assembly 30 such that one of the window panes 50, 51 is slidably movable relative to the inner frame assembly 30 to vent, while the other is fixed in position. The window pane 50 may include a handle or grip 53 formed thereon to assist in moving the window pane 50 from side to side within the inner frame assembly 30.

As described above, a vertical post 55 extends from the lower portion 45 to the upper portion 40 of the inner frame assembly 30. A latch mechanism 60 is disposed at the upper end of the vertical post 55. In one aspect of the present invention, the latch mechanism is disposed within a groove 59 formed in the vertical post 55 and attached using appropriate fasteners or joining operations. In this manner, the latch mechanism 60 is positioned within the width of the vertical post 55. A latch handle 65 is slidingly received by the vertical post 55 on an opposing side 56 of the vertical post 55 to that of the latch mechanism 60. The latch handle 65 is operably coupled to the latch mechanism 60 for actuating the latch mechanism 60 between open and locked positions. The latch handle 65 does not extend beyond a depth profile of the window assembly. This low profile attribute allows the window assembly 5 to be tilted without interference from the latch handle 65. In one aspect of the present invention the latch mechanism 60 may be biased toward the locked position. The vertical post 55 may include stepped portions 57 that mate with a corresponding notch 67 formed on the latch handle 65, as will be discussed in more detail below.

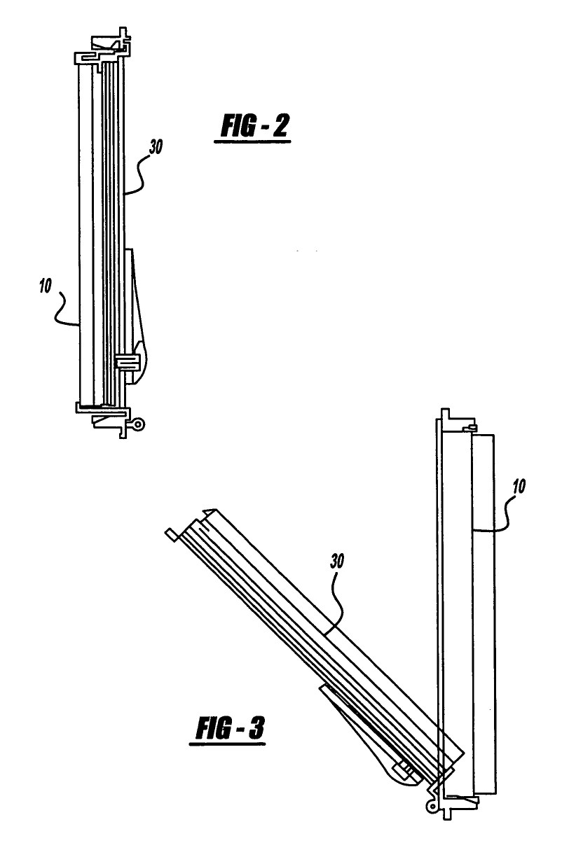

Referring to FIGS. 1-4, it can be seen that the inner frame assembly 30 is nested within the outer frame assembly 10 to allow for pivotal movement of the inner frame assembly 30 relative to the outer frame assembly 10. In one aspect, a pair of hinges 70 is attached to the lower portions 25, 45 of the outer 10 and inner 30 frame assemblies to allow for pivotal movement of the inner frame assembly 30 relative to the outer frame assembly 10. The outer frame assembly 10 may be attached to a trailer or other device using a clamp ring 77. Actuation of the latch mechanism 60 via the latch handle 65 allows for pivotal movement of the inner frame assembly 30 from a locked position shown in FIG. 2 to that of the open and pivoted position shown in FIGS. 3 and 11.

Referring to FIGS. 5 and 6, there is shown the vertical post 55, latch handle 65 and latch mechanism 60 shown in both the locked and unlocked or open positions, respectively. As stated above, the vertical post 55 extends from a lower portion 45 of the inner frame assembly 30 to the upper portion 40 of the inner frame assembly 30. The vertical post 55 may be attached to the inner frame assembly 30 by any appropriate structure including mechanical connections such as crimping or bonding or may otherwise be attached to the inner frame assembly with appropriate fasteners such as screws, bolts, rivets or the like. Additionally, the vertical post 55 may be attached using other joining operations such as welding, soldering or the use of any appropriate adhesive.

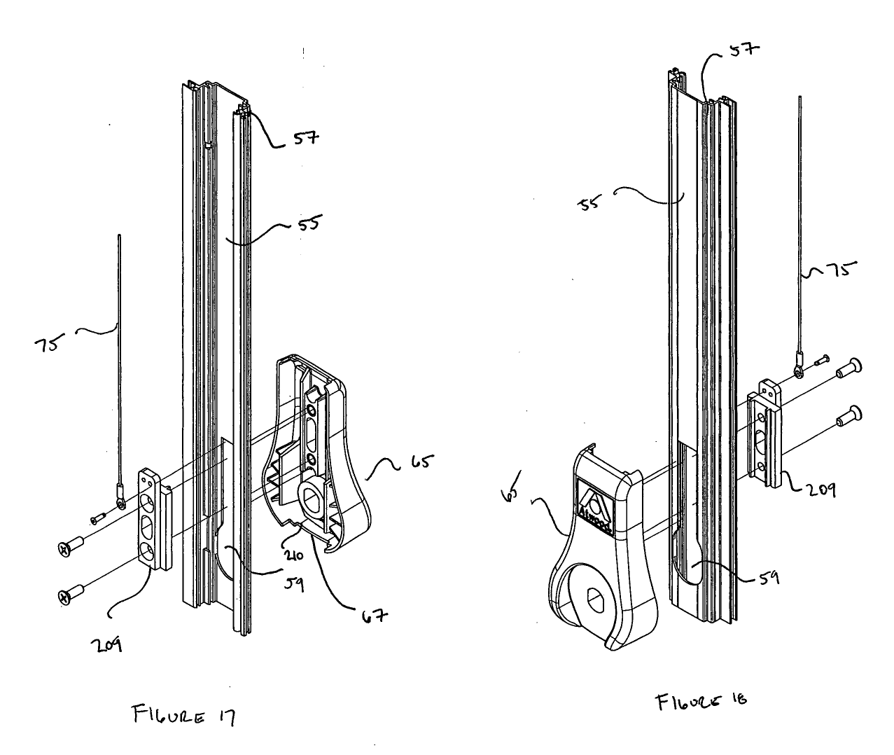

As can be seen in FIGS. 5, 6, 17 and 18 the release handle 65 is lineally coupled to the vertical post 55 for sliding movement relative to the vertical post 55. The notch 67 formed on a rear surface 210 of the latch handle 65 positions the latch handle 65 on the stepped portion 57 of the vertical post 55. The latch handle 65 maybe fastened to the vertical post 55 using fasteners that extend through a travel slot 59 formed in the vertical post 55 and are received in an attachment portion 209 of the latch handle, that is coupled to the latch handle 65, as best shown in FIG. 17. Additionally, the cable 75 may be attached to the attachment portion 209 to couple the latch handle 65 with the latch mechanism 60. In this manner, the latch handle 65 is movable lineally about the vertical post 55. An elongated actuating member such as a rod, strap or cable 75 is connected at one end to the release handle 65 and at another end to the latch mechanism 60. In this manner, as the release handle 65 is lineally slid relative to the vertical post 55, the cable 75 moves a latch pin 80 of the latch mechanism 60 from an extended position shown in FIG. 5 to a retracted position shown in FIG. 6. As stated above, the latch mechanism 60 is disposed at the upper end of the vertical post 55 for engagement with the outer frame assembly 10 or a latch receiver formed thereon. The latch mechanism 60 may include a catch such as a latch pin 80 that is movable lineally with respect to the vertical post 55, as described above or may include other latch types, such as hook members, cams, levers or other structures capable of actuation between locked and unlocked positions. The latch mechanism 60 of the present invention is an integrated component of the window assembly 5 and does not need to be separately assembled and attached in addition to the window as is the practice for prior art windows.

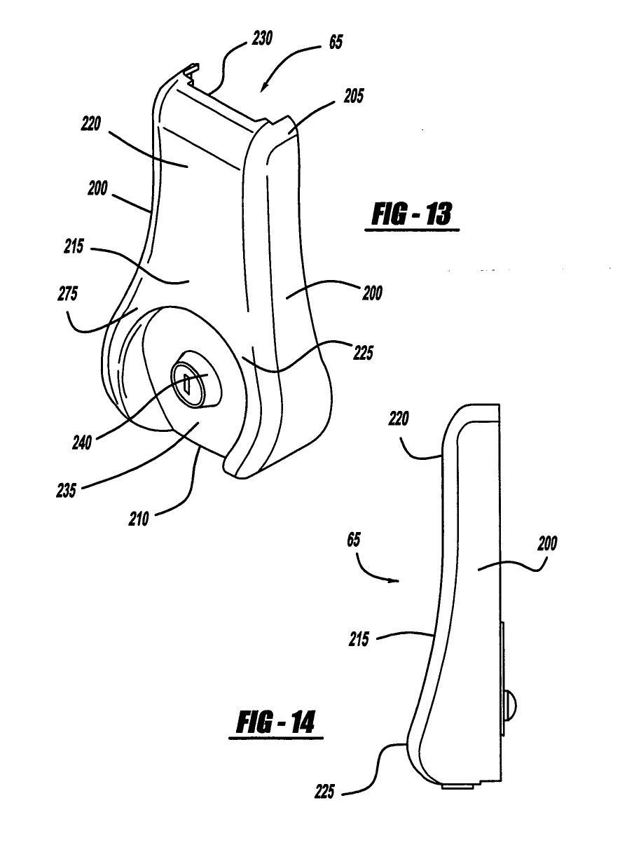

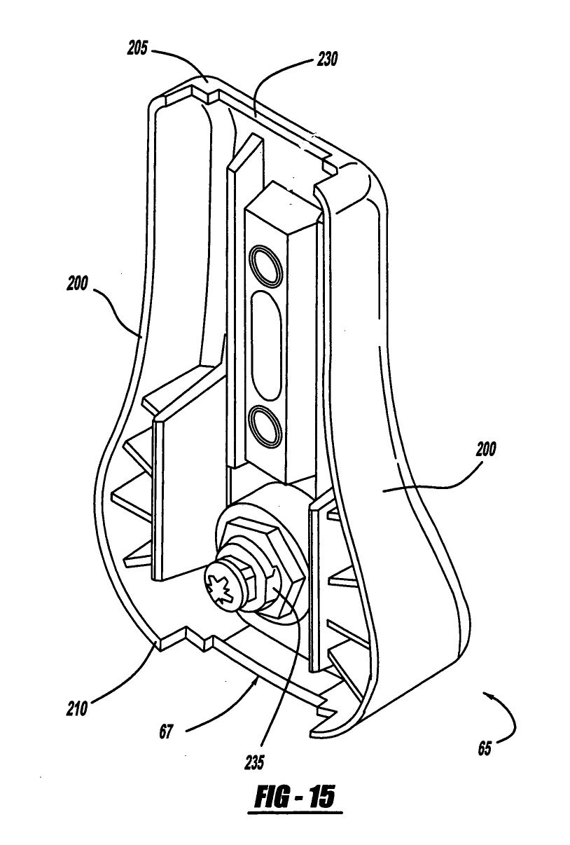

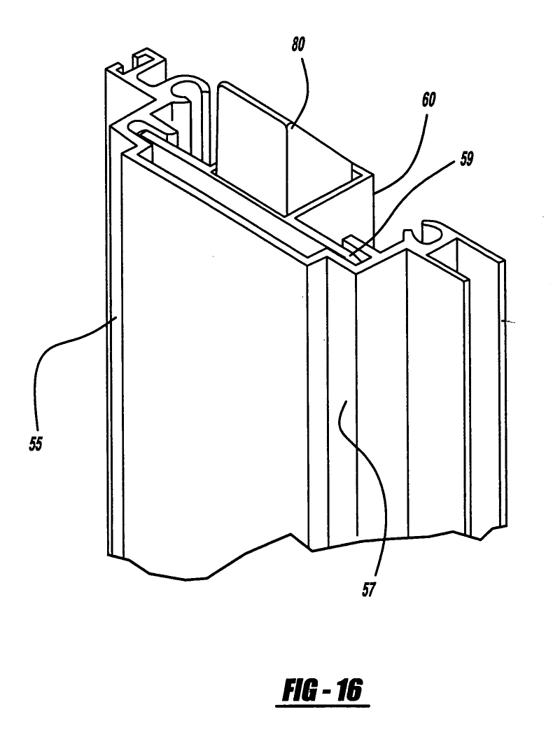

Referring to FIGS. 13 and 14 there is shown the latch handle 65 according to one aspect of the invention. The latch handle 65 includes opposing side surfaces 200 and opposing front and rear surfaces 205, 210. A top surface 215 is bounded by the opposing side surfaces 200 and the opposing front and rear surfaces 205, 210. The top surface 215 is positioned a suitable distance above the vertical post 55 defining a depth profile and away from the window pane 50 to allow easy manipulation by an operator while still allowing the window or door to open fully without interference from the latch handle 65. In one aspect of the invention the depth profile may be from 0.75 of an inch to 1.75 of an inch from the vertical post 55.

The top surface 215 includes a top portion 220 and a bottom portion 225. The top potion 220 connects to the front surface 205 of the latch handle 65 and includes a gripping recess 230 formed therein. In one aspect of the present invention, the top portion 220 may have a width profile of from 2 to 4 inches. The gripping recess 230 is sized and shaped to allow an operator to place their fingers in the gripping recess 230 to move the latch handle 65 lineally, as described previously above. In this manner, the operator slides the latch handle 65, as opposed to pulling on the latch handle towards the operator as with prior art designs, avoiding the possibility of the window tilting downward without the support of the operator's hand. In the present invention, an operator's hand is positioned on the latch handle 65 preventing the problem outlined above. The bottom portion 225 of the top surface 215 is larger than the top portion 220 to support a hand of an operator. The bottom portion 225 has a rounded shape, as best seen in FIG. 13 that accommodates the palm of the operator preventing the hand from slipping when moving the latch handle 65. In one aspect of the present invention, the width profile of the bottom portion 225 may range from 3 to 5 inches. In addition, the top surface 215 has a curved profile, best shown in FIG. 14 wherein the top surface 215 curves upward in a direction toward the bottom portion 225 of the top surface 215, again preventing slippage of the hand of the operator, as well as providing an ergonomic shape to the latch handle 65.

The bottom portion 225 also includes a depression 230 formed therein. The depression 230 houses a lock 235. The depression 230 is sized such that a key may be turned in the lock without interference with the latch handle 65.

In use an operator positions their hand on the latch handle 65 such that the palm of the operator is supported on the bottom portion 225 of the top surface 215. The operator's fingers then close on the recess 230 formed at the top portion 220 of the top surface 215. The operator may then slide the latch handle 65 lineally, as described above, to actuate the window assembly 5 between the locked and open positions.

Additionally, in use, the window panes 50, 51 may be moved from side to side relative to the inner frame assembly 30, such that the window panes 50, 51 slide within the channels 37 formed in the inner frame assembly 30 and vertical post 55. Additionally, a person may actuate the release handle 65, as described above, such that the cable 75 linking the release handle 65 to the latch mechanism 60 pulls the latch pin 80 from the locked position shown in FIGS. 2 and 5 to the open position shown in FIGS. 3 and 6. When the latch pin 80 is moved to the open position, the latch pin 80 no longer engages the outer frame assembly 10, allowing for pivotal movement of the inner frame assembly 30 relative to the outer frame assembly 10, as shown in FIG. 3. As outlined above, the inner frame assembly 30 is pivotally coupled via the hinges 70 to the outer frame assembly 10 such that the inner frame assembly 30 and window panes 50, 51 may be pivoted downward, allowing access to an inner space of a trailer or other device that houses the window assembly 5 of the present invention.

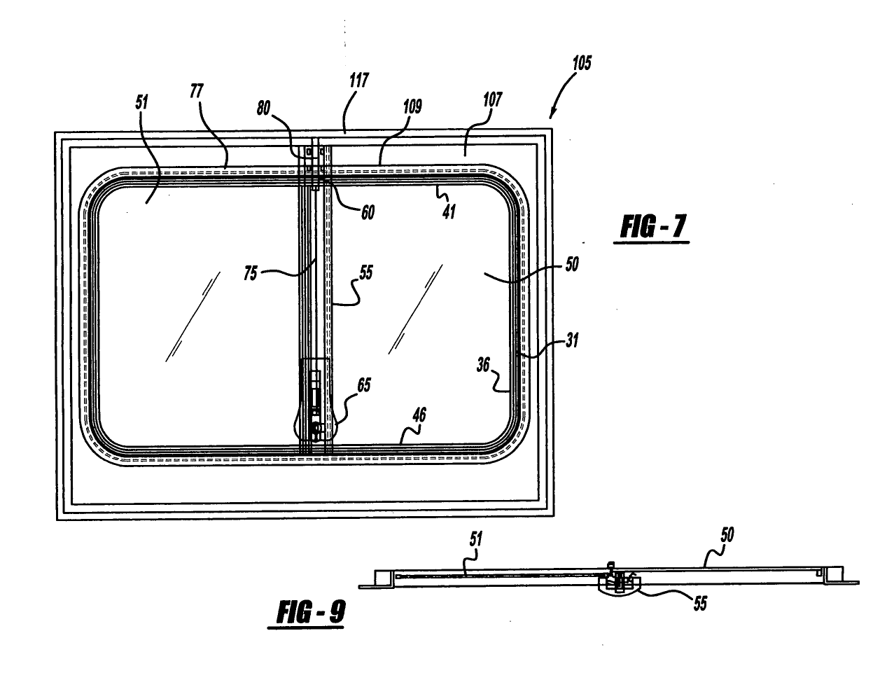

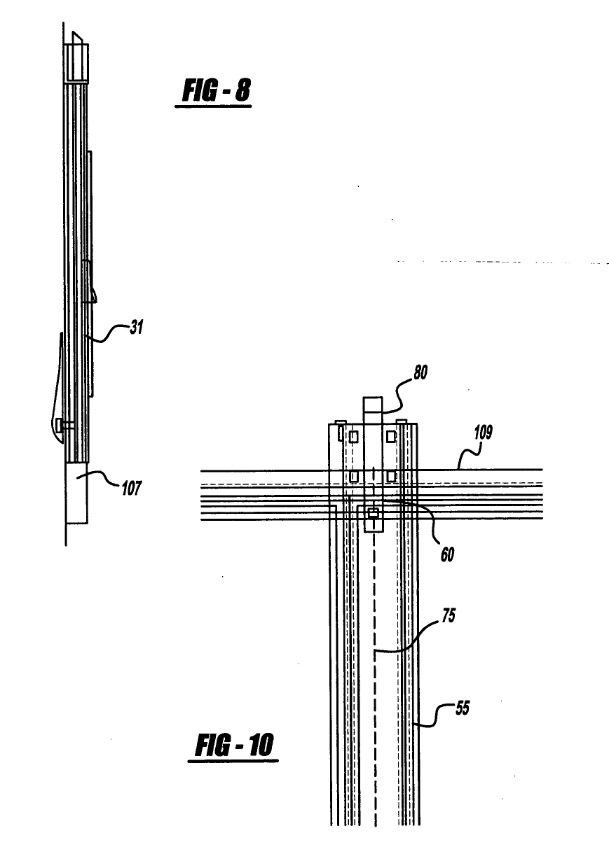

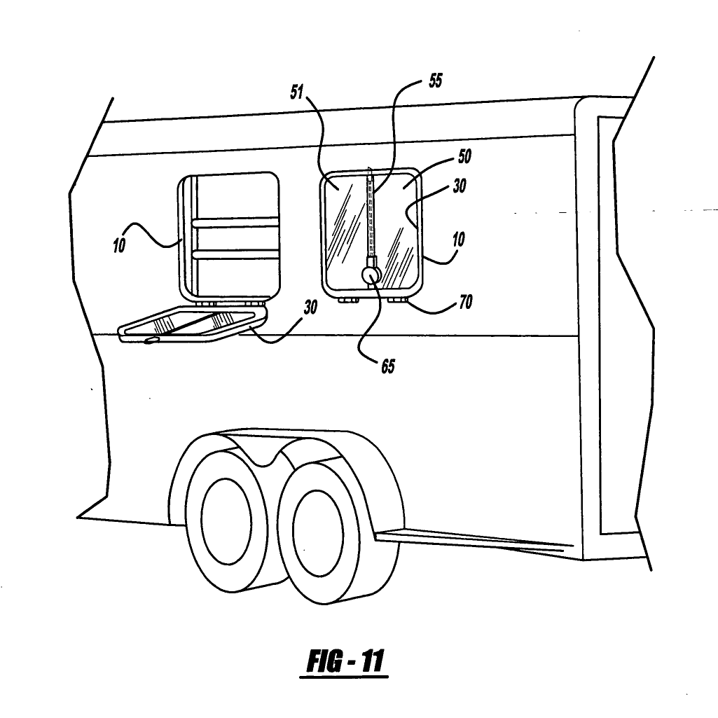

Referring to FIGS. 7 through 10, there is shown a second embodiment of the window assembly 105 of the present invention. As with the previously described first embodiment, the window assembly 105 of the second embodiment includes a vertical post 55, and a latch mechanism 60 and latch handle 65, similar to those previously described above. As with the first embodiment, the latch mechanism is integrated into the frame assembly 31. However, in the second embodiment, a frame member 31 is not hingedly coupled to the outer frame assembly 10, as described with respect to the previous first embodiment. The frame member 31 of the second embodiment 105 includes the channels 37 described above with reference to the inner frame assembly and may be included as a component of a modular closure panel 107 for use in a trailer or other such device.

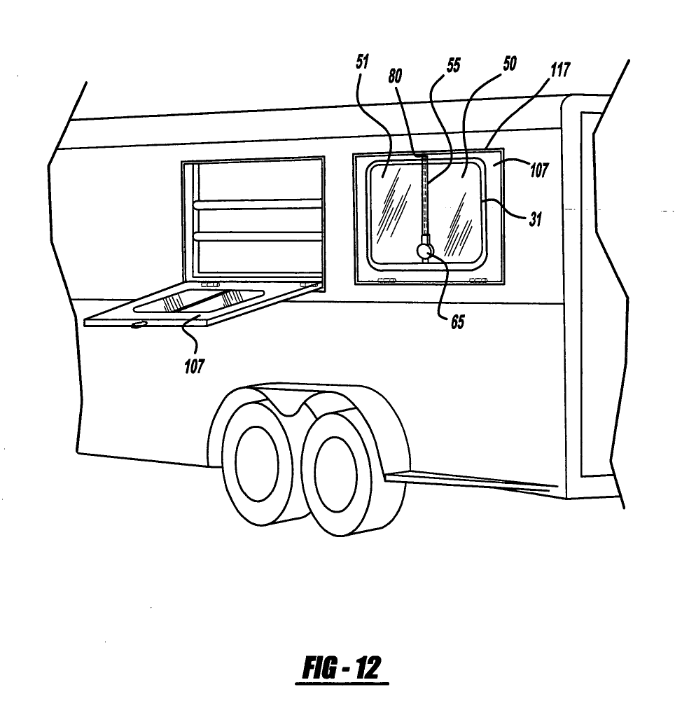

The vertical post 55 in the second embodiment extends from a lower portion 46 of the frame member 31 beyond an outer periphery 109 of the upper portion 41 of the frame member 31, as best seen in FIGS. 7 and 10. In this manner, the latch mechanism 60 disposed at an upper end of the vertical post 55 passes beyond a closure panel 107, such that the latch pin 80 can engage with a frame 117 of the closure panel 107. The latch release handle 65 and latch mechanism 60 are operably coupled, as previously described with respect to the first embodiment.

As can be seen in FIG. 7, the frame member 31 may connected to the closure panel 107. The closure panel 107 may include a frame 117 that is positioned about the closure panel 107 and connects the closure panel 107 with a trailer. The frame member 31 may be hingedly connected to the frame 117 via hinges 70, similar to the arrangement described above between the inner frame assembly 30 and outer frame assembly 10. The closure panel 107 may be utilized as a modular component in trailer that does not require a separate latch mechanism to operate the closure panel 107. The closure panel 107 can be dropped down or pivoted relative to the door assembly, as best seen in FIG. 12, similar to the relationship described above with respect to the inner frame assembly 30 and outer frame assembly 10.

In use, as the release handle 65 is actuated, the cable 75 linking with the latch mechanism 60 pulls the catch or latch pin 80 to the unlocked position. When in the unlatched or open position, the latch pin 80 no longer engages the frame 117, allowing for pivotal movement of the entire closure panel 107. Because the latch mechanism 60 is attached to the vertical post 55 and extends beyond an outer periphery 109 of the frame member 31, the second embodiment of the window assembly 105 may be utilized as a modular component of a closure panel allowing for release of the closure panel and easy incorporation into a trailer.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A modular tilt-down window assembly for a horse trailer comprising;
an inner frame assembly;
an outer frame assembly for pivotally supporting the inner frame assembly in a tilt-down mode;
a latch mechanism for releasing the inner frame assembly relative to the outer frame assembly in the tilt-down mode, wherein the latch mechanism is an integrated component of the window assembly, forming a modular window assembly.

2. The modular tilt-down window assembly of claim 1 including a least one window pane disposed in the inner frame assembly.

3. The modular tilt-down window assembly of claim 2 including a vertical post extending from a lower portion of the inner frame assembly to an upper portion of the inner frame assembly.

4. The modular tilt-down window assembly of claim 3 including a latch handle supported by the vertical post and operably connected to the latch mechanism.

5. The modular tilt-down window assembly of claim 4 including an elongated actuating member connected between the latch handle and the latch mechanism, the latch mechanism positioned at a top portion of the modular window assembly and the latch handle positioned below the latch mechanism.

6. The modular tilt-down window assembly of claim 3 wherein the inner frame assembly includes a plurality of window panes and wherein the vertical post provides a division between at least two of the plurality of window panes and wherein one of the window panes vents.

7. The modular tilt-down window assembly of claim 6 wherein one of the window panes is fixed and the other is slidable relative to the inner frame assembly.

8. The modular tilt-down window assembly of claim 5, wherein the elongated actuating member is a cable disposed in the vertical post and the wherein the latch mechanism is actuated between a locked position and an open position.

9. The modular tilt-down window assembly of claim 8 wherein the latch mechanism is biased to the locked position.

10. The modular tilt-down window assembly of claim 4, wherein the latch handle does not extend beyond a depth profile of the outer frame assembly.

11. The modular tilt-down window assembly of claim 4 wherein the latch handle is lineally coupled to the vertical post for sliding movement of the latch handle relative to the vertical post.

12. The modular tilt-down window assembly of claim 4, wherein the vertical post includes stepped portions formed thereon mating with a notch formed on the latch handle for aligning the latch handle with the vertical post for lineal movement of the latch handle relative to the vertical post.

13. The modular tilt-down window assembly of claim 5 wherein the latch mechanism is in contact with the outer frame assembly and operably connected to the elongated actuating member.

14. The modular tilt-down window assembly of claim 13 wherein lineal movement of the latch handle relative to the vertical post moves the latch mechanism out of contact with the outer frame assembly wherein the latch mechanism is actuated to an open position allowing pivotal movement of the inner frame assembly relative to the outer frame assembly.

15. The modular tilt-down window assembly of claim 2 wherein the inner frame assembly includes channels formed therein for receiving the at least one window pane.

16. The modular tilt-down window assembly of claim 15 wherein the at least one window pane includes slides formed thereon that are received in the channels.

17. The modular tilt-down window assembly of claim 1 wherein the latch mechanism extends beyond the inner frame assembly toward the outer frame assembly.

18. The modular tilt-down window assembly of claim 3 wherein the latch mechanism is positioned within a width of the vertical post.

19. A modular tilt-down window assembly for a horse trailer comprising;
an inner frame assembly including at least one window pane, a vertical post and a latch mechanism having a catch, the vertical post extending from a lower portion of the inner frame assembly to an upper portion of the inner frame assembly;
an outer frame assembly for pivotally supporting the inner frame assembly in a tilt-down mode;
a latch handle supported by the vertical post and operably connected to the latch mechanism;
an elongated actuating member connected between the latch handle and the latch mechanism, the latch mechanism positioned at a top portion of the modular window assembly and the latch handle positioned below the latch mechanism.

20. A modular window assembly for tilt-down of a closure panel comprising;
a window frame assembly having an integrated latch mechanism extending beyond a periphery of the window frame assembly for actuating a closure panel.

21. The modular window assembly for tilt-down of a closure panel of claim 20 including a least one window pane disposed in the window frame assembly.

22. The modular window assembly for tilt-down of a closure panel of claim 21 including a vertical post extending from a lower portion of the window frame assembly beyond an upper portion of the window frame assembly.

23. The modular window assembly for tilt-down of a closure panel of claim 22 wherein the vertical post passes through a slot formed in the window frame assembly for extending beyond the periphery of the window frame assembly.

24. The modular window assembly for tilt-down of a closure panel of claim 22 including a latch handle supported by the vertical post and operably connected to the latch mechanism.

25. The modular window assembly for tilt-down of a closure panel of claim 24 including an elongated actuating member connected between the latch handle and the latch mechanism, the latch mechanism positioned at a top portion of the modular window assembly and the latch handle positioned below the latch mechanism.

26. The modular window assembly for tilt-down of a closure panel of claim 22 wherein the window frame assembly includes a plurality of window panes and wherein the vertical post provides a division between at least two of the plurality of window panes and wherein one of the window panes vents.

27. The modular window assembly for tilt-down of a closure panel of claim 26 wherein one of the window panes is fixed and the other is slidable relative to the window frame assembly.

28. The modular window assembly for tilt-down of a closure panel of claim 25, wherein the elongated actuating member is a cable disposed in the vertical post and the wherein the latch mechanism is actuated between a locked position and an open position.

29. The modular window assembly for tilt-down of a closure panel of claim 28 wherein the latch mechanism is biased to the locked position.

30. The modular window assembly for tilt-down of a closure panel of claim 24, wherein the latch handle does not extend beyond a depth profile of the window frame assembly.

31. The modular window assembly for tilt-down of a closure panel of claim 24 wherein the latch handle is lineally coupled to the vertical post for sliding movement of the latch handle relative to the vertical post.

32. The modular window assembly for tilt-down of a closure panel of claim 24, wherein the vertical post includes stepped portions formed thereon mating with a notch formed on the latch handle for aligning the latch handle with the vertical post for lineal movement of the latch handle relative to the vertical post.

33. The modular window assembly for tilt-down of a closure panel of claim 21 wherein the window frame assembly includes channels formed therein for receiving the at least one window pane.

34. The modular window assembly for tilt-down of a closure panel of claim 33 wherein the at least one window pane includes slides formed thereon that are received in the channels.

35. The modular window assembly for tilt-down of a closure panel of claim 22 wherein the latch mechanism is positioned within a width of the vertical post.

36. The modular window assembly for tilt-down of a closure panel of claim 20 wherein the window frame member is positioned within a closure panel forming a modular component.

37. A modular window assembly for tilt-down of a closure panel comprising;
a window frame assembly including at least one window pane, a vertical post and an integrated latch mechanism, the vertical post extending from a lower portion of the frame assembly beyond a periphery of the window frame assembly;
a latch handle supported by the vertical post and operably connected to the latch mechanism;
an elongated actuating member connected between the latch handle and the latch mechanism, the latch mechanism positioned at a top portion of the modular window assembly and the latch handle positioned below the latch mechanism.

38. A latch handle for a modular tilt-down window assembly comprising:
opposing front and rear surfaces connected to opposing side surfaces;
separated top and bottom surfaces connected to the opposing front and rear and opposing side surfaces, the top surface including top and bottom portions;
the top surface having a curved profile wherein the top surface curves upward in a direction toward the bottom portion of the top surface for accommodating the hand of an operator.

39. The latch handle for a modular tilt-down window assembly of claim 38 wherein the bottom portion of the top surface has a size larger than the top portion of the top surface.

40. The latch handle for a modular tilt-down window assembly of claim 38 wherein the bottom portion of the top surface includes a rounded shape.

41. The latch handle for a modular tilt-down window assembly of claim 38 wherein the bottom portion of the top surface includes a depression formed therein and housing a lock, the depression sized to allow turning of a key within the lock without interference with the latch handle.

42. The latch handle for a modular tilt-down window assembly of claim 38 wherein the top portion of the top surface includes a gripping recess formed therein.

43. The latch handle for a modular tilt-down window assembly of claim 38 wherein the latch handle has a depth profile of from 0.75 of an inch to 1.75 of an inch.

44. The latch handle for a modular tilt-down window assembly of claim 38 wherein the bottom portion has a width profile of from three to five inches.

45. The latch handle for a modular tilt-down window assembly of claim 38 wherein the top portion has a width profile of from two to four inches.

46. A modular tilt-down window assembly for a horse trailer comprising;
an inner frame assembly including at least one window pane, a vertical post and a latch mechanism having a catch, the vertical post extending from a lower portion of the inner frame assembly to an upper portion of the inner frame assembly;
an outer frame assembly for pivotally supporting the inner frame assembly in a tilt-down mode;
a latch handle having opposing front and rear surfaces connected to opposing side surfaces and separated top and bottom surfaces connected to the opposing front and rear and opposing side surfaces, the top surface including top and bottom portions, the top surface having a curved profile wherein the top surface curves upward in a direction toward the bottom portion of the top surface for accommodating the hand of an operator, the latch handle supported by the vertical post and operably connected to the latch mechanism;
an elongated actuating member connected between the latch handle and the latch mechanism, the latch mechanism positioned at a top portion of the modular window assembly and the latch handle positioned below the latch mechanism.

47. A modular window assembly for tilt-down of a closure panel comprising;
a window frame assembly including at least one window pane, a vertical post and an integrated latch mechanism, the vertical post extending from a lower portion of the frame assembly beyond a periphery of the window frame assembly;
a latch handle having opposing front and rear surfaces connected to opposing side surfaces and separated top and bottom surfaces connected to the opposing front and rear and opposing side surfaces, the top surface including top and bottom portions, the top surface having a curved profile wherein the top surface curves upward in a direction toward the bottom portion of the top surface for accommodating the hand of an operator, the latch handle supported by the vertical post and operably connected to the latch mechanism;
an elongated actuating member connected between the latch handle and the latch mechanism, the latch mechanism positioned at a top portion of the modular window assembly and the latch handle positioned below the latch mechanism.
